(19) United States
(12) Patent Application Publication
(10) Pub. No.: US 2005/0196632 A1
(43) Pub. Date: Sep. 8, 2005

(54) Protective layer for optical coatings with enhanced corrosion and scratch resistance

(75) Inventors: Peter Alan Maschwitz, Sebastopol, CA (US); Herbert David Johnson, Kingsport, TN (US)

Correspondence Address: ROTHWELL, FIGG, ERNST & MANBECK, P.C., 1425 K STREET, N.W., SUITE 800, WASHINGTON, DC, 20005, US

(73) Assignee: AFG Industries, Inc., Kingsport, TN (US)

(21) Appl. No.: 11/013,700

(22) Filed: Dec. 17, 2004

Related U.S. Application Data
(60) Provisional application No. 60/530,244, filed on Dec. 18, 2003.

(51) Int. Cl. B32B 15/00

(52) U.S. Cl. 428/615; 428/632; 428/655; 428/627; 428/434

(57) ABSTRACT

An oxidizable metal silicide or metal aluminide is used as one of the outer layers of an optical coating to provide a corrosion and scratch resistant barrier. This layer is initially deposited in an unoxidized or partially oxidized state. In this chemical state it provides corrosion protection to the layers underneath. The metal compound or intermetallic layer has hardness properties greater than most metals and therefore provides significant scratch protection.

This application claims the benefit of U.S. Provisional 60/530,244 filed Dec. 18, 2003.

### FIELD OF THE INVENTION

The present invention relates, generally, to outer protective layers which are applied on top of optical coatings on various substrates and, more specifically, to a protective layer for optical coatings that provides enhanced corrosion and scratch protection for the layers underneath. In particular, the present invention relates to the use of oxidizable silicides, and intermetallics such as aluminide compounds as an outer layer of an optical coating.

### DESCRIPTION OF RELATED ART

Low emissivity optical coatings or optical coatings containing infrared reflecting metals, can be deposited on transparent substrates to reduce the transmission of some or all of the infra-red radiation incident on the substrates. Anti-reflected thin silver coatings have been found to reflect a high proportion of infra-red radiation but allow visible light to pass through. These desirable properties have lead to the use of anti-reflected silver coated substrates in various applications such as window glass where the coating improves the thermal insulation of the window. Low emissivity silver coatings are described in U.S. Pat. Nos. 4,749,397 and 4,995,895. Vacuum deposited low emissivity coatings containing silver are presently sold in the fenestration marketplace.

U.S. Pat. No. 4,995,895 teaches the use of oxidizable metals as haze reduction topcoats useful for protecting temperable low-e coatings. This patent is directed to methods of reducing haze resulting from exposure to temperatures over 600° C.

Metal, metal alloy and metal oxide coatings have been applied to low emissivity silver coatings to improve the properties of the coated object. U.S. Pat. No. 4,995,895 describes a metal or metal alloy layer which is deposited as the outermost layer of the total layers applied to a glass base. The metal or metal alloy layer is oxidized and acts as an anti-reflection coating. U.S. Pat. No. 4,749,397 describes a method where a metal oxide layer is deposited as an antireflection layer. Sandwiching the silver layer between anti-reflection layers optimizes light transmission.

Unfortunately, optical coatings are frequently damaged during shipping and handling by scratching, by exposure to corrosive environments and by thermal damage during heat treatment or bending. Silver based low-emissivity coatings are particularly susceptible to corrosion problems. Most low emissivity stacks in use today make use of barrier layers somewhere in or on the low emissivity thin film stack to reduce these problems. Thin film barriers function to reduce the corrosion of silver layers from water vapor, oxygen or other fluids. Some reduce damage from physical scratching of the low emissivity stack by virtue of their hardness or by lowering friction if they form the outer layer.

Pure metals are currently used as oxidizable corrosion and scratch resistant layers. Metal layers are known to be effective barriers due to their ability to physically and chemically inhibit diffusion. If the layer is non-porous, diffusion is physically blocked.

Metal compound layers may also chemically block diffusion by reacting with oxygen or water as the fluid travels through a defect to stop the movement of all chemically bound fluid molecules. Not only does this reaction process stop fluid movement, the fluid molecules attached to the walls of the pinhole now may physically block movement of subsequent molecules. The more reactive metal compounds are particularly effective for chemical blocking. Generally metals are not as hard as metal compounds or mixtures of metal and metal compounds and are not effective at scratch protection. Scratch protection is often accomplished by the use of carbon or metal oxide layers deposited on the air side of an optical stack.

Sputtered carbon protective layers have been utilized to provide scratch protection but provide very little corrosion protection. In addition, carbon oxidizes only at temperatures above 400° C.

Oxidizable stoichiometric metal nitrides have been used as protective corrosion and scratch resistant layers. Similarly to carbon, stoichiometric metal nitrides oxidize only at high temperatures and provide good scratch protection but little corrosion protection.

Tempering can reduce the corrosion problems associated with silver based low-emissivity coatings. Tempering can result in an atomic level restructuring to a lower energy state and may render the silver far less prone to corrosion. Tempering may also improve the hardness and scratch resistance of optical coatings. However, until these optical coatings are tempered, the coatings remain particularly susceptible to damage from scratching and corrosion. Scratches in an optical coating frequently do not become visible until after the coating is heated and tempered, which can cause the scratches to grow and propagate.

Thus, there exists a need in the art for a protective layer that has sufficient hardness and durability to reduce damage from corrosion and scratching while allowing the transmission of visible light.

It is a purpose of different embodiments of this invention to fulfill the above described needs in the art, and/or other needs which will become apparent to the skilled artisan once given the following disclosure.

### SUMMARY OF THE INVENTION

The primary object of the present invention is to overcome the deficiencies of the prior art described above by providing a protection layer with sufficient hardness and durability to reduce damage from corrosion and scratching while allowing the transmission of visible light.

Another object of the present invention is to produce a protection layer that substantially reduces corrosion and scratching with minimal changes to the performance or appearance of the optical coatings. The protection layer must also be easy to apply with minimal disruption to the optical coating process.

The present invention achieves all of the above discussed objectives by using an oxidizable metal compound or a co-deposited mixture of metal and metal compound as one of the outer layers of an optical coating to provide a corrosion and scratch resistant barrier. This layer is initially deposited in a primarily unoxidized or un-nitrided state. In this chemical state it provides corrosion protection to the layers underneath. The layer also has hardness properties greater than most metals and therefore provides significant scratch protection.

Further features and advantages of the present invention, as well as the structure and composition of preferred embodiments of the present invention are described in detail below with reference to the accompanying drawings.

### BRIEF DESCRIPTION OF THE DRAWINGS

The preferred embodiments of this invention will be described in detail with reference to the following figures. These figures are intended to illustrate various embodiments of the present invention and are not intended to limit the invention in any manner.

FIG. 1 shows data for ZrSi₂ corrosion and scratch resistant layers. The ZrSi₂ was sputtered from a 14.875 by 4.75 inch rectangular ZrSi₂ chemical compound target in argon atmosphere.

FIG. 2 shows data for Ti₃AL corrosion and scratch resistant topcoat layers.

FIG. 3 is a diagram of a temperable, low-e stack with a corrosion and scratch resistant topcoat layer

FIG. 4 is a diagram of a double silver temperable low-e stack with corrosion and scratch resistant topcoat.

FIGS. 5-7 are diagrams of low-e stacks with corrosion and scratch resistant topcoats.

FIG. 8 shows a photo of single silver temperable low-e coating on glass with no corrosion and scratch protection topcoat after 200 strokes from the Scotch Brite test.

FIG. 9 shows a photo of single silver temperable low-e coating on glass with ZrSi co-sputtered corrosion and scratch protection topcoat after 200 strokes from the Scotch Brite test.

### DETAILED DESCRIPTION OF THE INVENTION

The present invention provides a corrosion and scratch resistant protective coating as an outer layer on an optical coating deposited on the air contacting surface of a silver containing thin film optical coating to inhibit the formation of scratches on and corrosion of the optical coating layers.

A transparent substrate is preferred and can be any heat resistant transparent material. Preferably, the transparent substrate is a glass that can be tempered by heating and quenching.

The protective coating involves the use of metal compounds such as suicides or intermetallics, mixtures of metal and silicides or mixtures of metal and metal intermetallic compounds which are capable of chemically reacting to a non-absorbing oxide. The scratch and corrosion protection layer can be between 3 to 10 nanometers (nm) thick and preferably is between 3 to 6 nm thick. Generally the corrosion protection is better while the layer exists as a metal compound than after it is converted to an oxide. Scratch resistance may be high in either state. The protective coating may result in a higher haze after heat treating.

The metal compound layer is optically absorbing and suitable for low-e stacks where lower transmission is desired or for heat treated coatings where the protective layer is thermally oxidized to a transparent oxide.

The oxidation process occurs if the metal is exposed to an energy source such as heat or a more chemically reactive environment than air. Thus, if the thin film stack is heated in an oxidizing atmosphere (e.g. heat treatable or bendable low emissivity coatings), thicker metal compound layers may be used. The thickness may be from 3 to 10 nm. The greater thickness results in better corrosion and scratch protection. The metal compound layer is deposited thicker than 3 nm so that the layer provides an effective corrosion barrier prior to heat treatment. In order to provide effective scratch protection prior to heat treating the metal compound is preferably deposited at a thickness of 4 nm or more. In order to ensure that the metal compound layer is fully oxidized during the heat treating process, the layer is preferably deposited to a thickness of 8 nm or less, more preferably 6 nm or less. When the metal compound layer is fully oxidized, it has little effect on absorption, but may have a small optical interference effect.

Suitable oxidizable metal compounds and intermetallics include suicides and aluminides. The metal portion of these intermetallic compounds can be: chromium, iron, titanium, zirconium, hafnium, niobium, tantalum, molybdenum, tungsten, iron, nickel, and/or aluminum. Silicon may be a non-metallic portion of the metal compound. In a preferred embodiment the metal portion of the compound is zirconium. The metal compounds can be slightly doped with nitrogen (0 to 30 atomic %) or oxygen (0 to 30 atomic %). The metal compounds are deposited on the optical coatings in an unoxidized or partially oxidized or nitrided state. Scratch resistance provided by the layer improves with the oxygen or nitrogen doping, however, corrosion resistance may decrease with doping over approximately 20 atomic %.

Any suitable method or combination of methods may be used to deposit the scratch and corrosion protection layer and the layers in the optical stack. Such methods include but are not limited to evaporation (thermal or electron beam), liquid pyrolysis, chemical vapor deposition, vacuum deposition and sputtering (e.g. magnetron sputtering) and co-sputtering. Different layers may be deposited using different techniques.

The low-e structure or silver containing thin film stack can be heat treated by heating to a temperature in the range of 400 to 700° C. followed by quenching to room temperature. Optical coatings including silver layers can be heat treated by heating to a temperature below the 960° C. melting point of silver followed by quenching to room temperature. For example, a low emissivity optical coating including a silver layer can be heat treated by heating to about 730° C. for a few minutes followed by quenching. Preferably, the glass and optical coatings are heat treated at a temperature of at least 550° C.

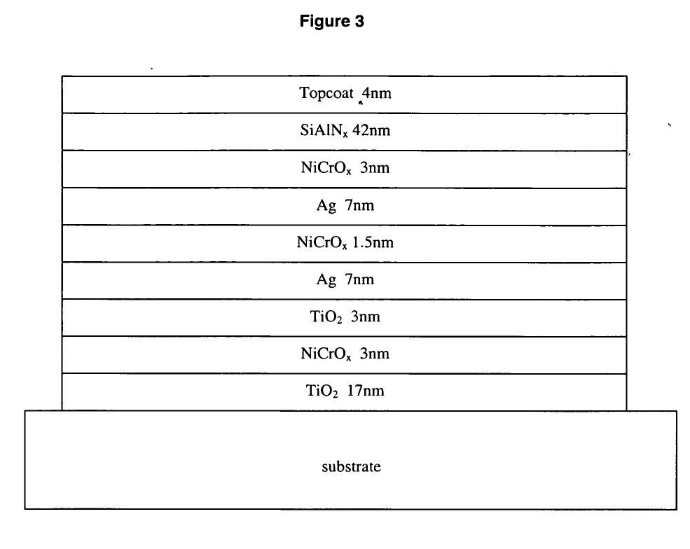

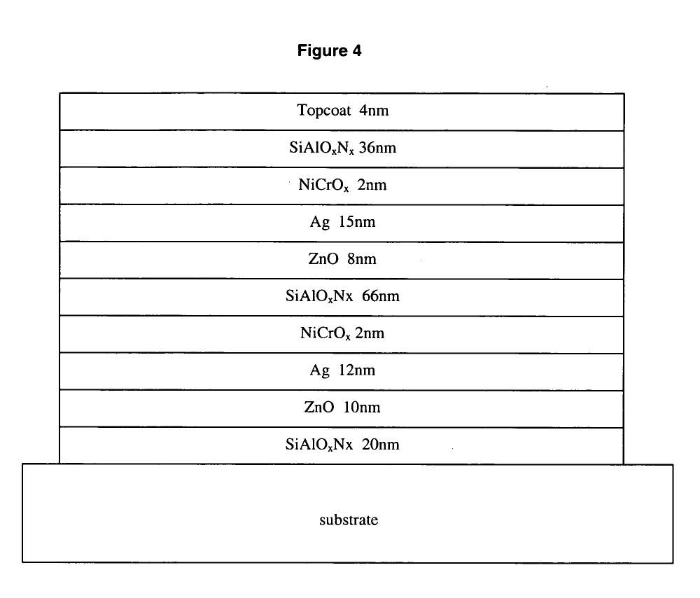

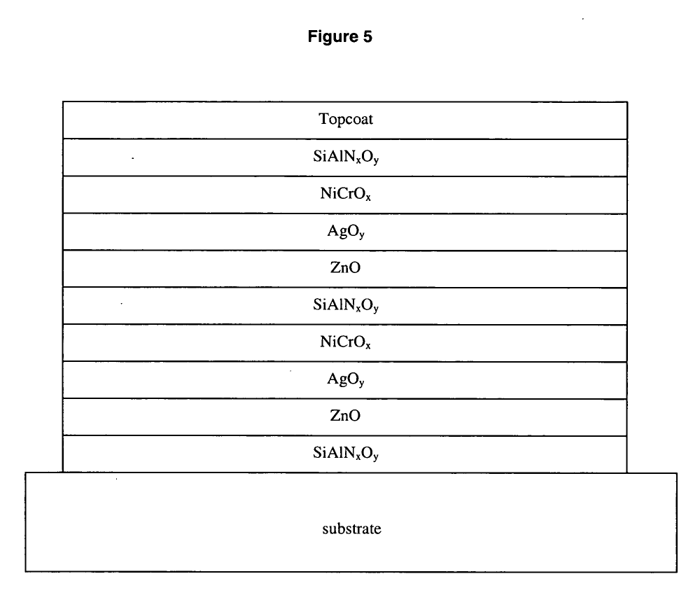

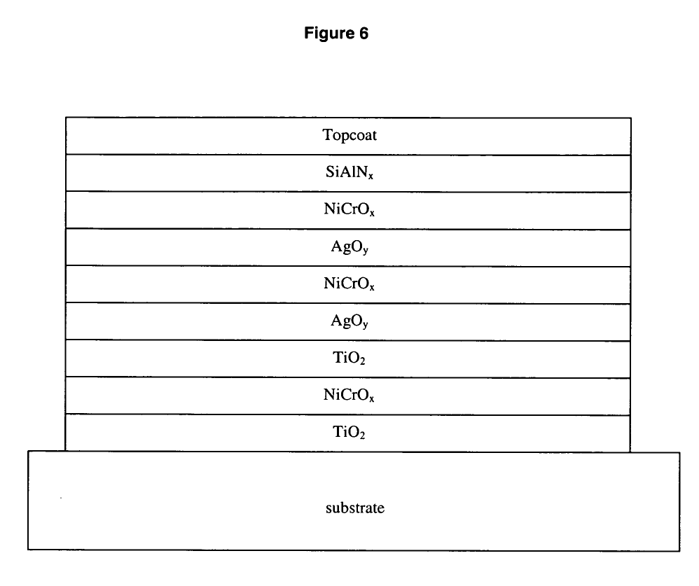

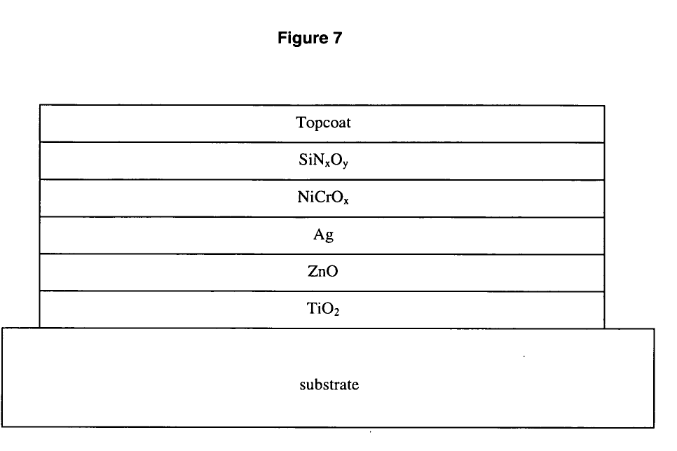

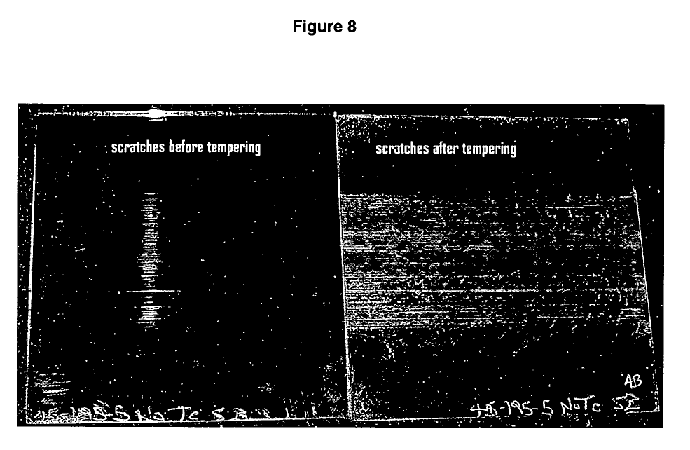

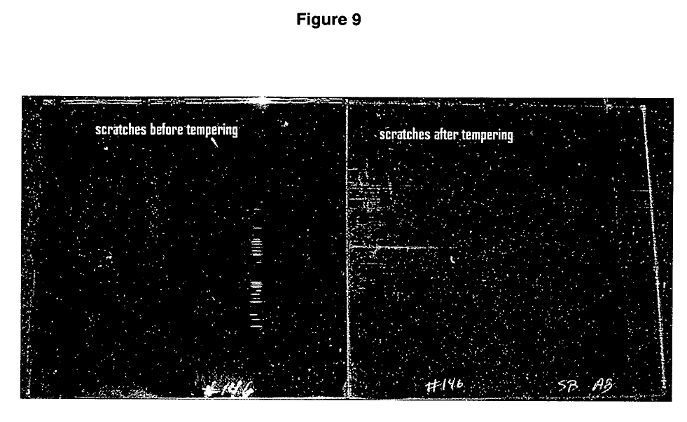

The metal compound protective layer according to the present invention can be deposited unoxidized or in a partially oxidized or nitrided state onto any suitable optical stack to improve the corrosion and scratch resistance. FIGS. 3-7 provide examples of suitable optical stacks. Various combinations of layers in an optical stack are also known in the art as shown in U.S. Pat. Nos. 4,995,895 and 4,749,397. The optical stack preferably includes at least one silver layer, at least one barrier layer to protect the silver layer during the sputtering process, and optionally at least one blocker, barrier or sacrificial layer which protects the silver layer from oxidizing during heat treatment. In a preferred embodiment of the present invention, the optical stack comprises layers of TiO₂, NiCrOₓ, TiO₂, Ag, NiCr, Ag, NiCrOₓ, and SiAlNₓ (Szczyrbowski, J., et al., Temperable Low Emissivity Coating Based on Twin Magnetron Sputtered TiO₂ and Si₃N₄, Society of Vacuum Coaters, pp. 141-146, 1999) with a protective layer comprised of a metal compound such as zirconium silicide. One skilled in the art understands that the layers in the stack can be arranged and changed in order to improve or modify the properties of the stack.

The aforesaid layers in the optical stack make up a solar control coating (e.g., a low-E or low emissivity type coating) which may be provided on glass substrates. The layer stack may be repeated on the substrate one or more times. Other layers above or below the described layers may also be provided. Thus, while the layer system or coating is “on” or “supported by” the substrate (directly or indirectly), other layers may be provided there between. Moreover, certain layers of the coating may be removed in certain embodiments, while others may be added in other embodiments of this invention without departing from the overall spirit of this invention.

As used in the present specification, the language “deposited onto” or “deposited on” means that the substance is directly or indirectly applied above the referenced layer. Other layers may be applied between the substance and the referenced layer.

Coated articles according to different embodiments of this invention may be used in the context of architectural windows (e.g., IG units), automotive windows, or any other suitable application. Coated articles herein may or may not be heat treated in different embodiments of this invention.

Certain terms are prevalently used in the glass coating art, particularly when defining the properties and solar management characteristics of coated glass. Such terms are used herein in accordance with their well known meaning. For example, as used herein:

Intensity of reflected visible wavelength light, i.e. “reflectance” is defined by its percentage and is reported as Rₓ Y or Rₓ (i.e. the RY value refers to photopic reflectance or in the case of TY photopic transmittance), wherein “X” is either “G” for glass side or “F” for film side. “Glass side” (e.g. “G”) means, as viewed from the side of the glass substrate opposite that on which the coating resides, while “film side” (i.e. “F”) means, as viewed from the side of the glass substrate on which the coating resides.

Color characteristics are measured and reported herein using the CIE LAB 1976 a*, b* coordinates and scale (i.e. the CIE 1976 a*b* diagram, III. CIE-C 2 degree observer), wherein:

L* is (CIE 1976) lightness units

a* is (CIE 1976) red-green units

b* is (CIE 1976) yellow-blue units.

Other similar coordinates may be equivalently used such as by the subscript “h” to signify the conventional use of the Hunter method (or units) III. C., 10° observer, or the CIE LUV u*v* coordinates. These scales are defined herein according to ASTM D-2244-93 “Standard Test Method for Calculation of Color Differences From Instrumentally Measured Color Coordinates” Sep. 15, 1993 as augmented by ASTM E-308-95, Annual Book of ASTM Standards, Vol. 06.01 “Standard Method for Computing the Colors of Objects by 10 Using the CIE System” and/or as reported in IES LIGHTING HANDBOOK 1981 Reference Volume.

The terms “emissivity” (or emittance) and “transmittance” are well understood in the art and are used herein according to their well known meaning. Thus, for example, the term “transmittance” herein means solar transmittance, which is made up of visible light transmittance (TY of Tᵥᵢₛ), infrared energy transmittance (T_{IR}), and ultraviolet light transmittance (Tᵤᵥ) Total solar energy transmittance (TS or Tₛₒₗₐᵣ) can be characterized as a weighted average of these other values. With respect to these transmittances, visible transmittance may be characterized for architectural purposes by the standard Illuminant C, 2 degree technique; while visible transmittance may be characterized for automotive purposes by the standard III. A 2 degree technique (for these techniques, see for example ASTM E-308-95, incorporated herein by reference). For purposes of emissivity a particular infrared range (i.e. 2,500-40,000 nm) is employed. Various standards for calculating/measuring any and/or all of the above parameters may be found in the aforesaid provisional application upon which priority is claimed herein.

The term Rₛₒₗₐᵣ refers to total solar energy reflectance (glass side herein), and is a weighted average of IR reflectance, visible reflectance, and UV reflectance. This term may be calculated in accordance with the known DIN 410 and ISO 13837 (December 1998) Table 1, p. 22 for automotive applications, and the known ASHRAE 142 standard for architectural applications, both of which are incorporated herein by reference.

“Haze” is defined as follows. Light diffused in many directions causes a loss in contrast. The term “haze” is defined herein in accordance with ASTM D 1003 which defines haze as that percentage of light which in passing through deviates from the incident beam greater than 2.5 degrees on the average. “Haze” may be measured herein by a Byk Gardner haze meter (all haze values herein are measured by such a haze meter and are given as a percentage of light scattered).

“Emissivity” (or emittance) (E) is a measure, or characteristic of both absorption and reflectance of light at given wavelengths. It is usually represented by the formula: E=1-Reflectance_{film}.

For architectural purposes, emissivity values become quite important in the so-called “mid-range”, sometimes also called the “far range” of the infrared spectrum, i.e. about 2,500-40,000 nm., for example, as specified by the WINDOW 4.1 program, LBL-35298 (1994) by Lawrence Berkeley Laboratories, as referenced below. The term “emissivity” as used herein, is thus used to refer to emissivity values measured in this infrared range as specified by ASTM Standard E 1585-93 entitled “Standard Test Method for Measuring and Calculating Emittance of Architectural Flat Glass Products Using Radiometric Measurements”. This Standard, and its provisions, are incorporated herein by reference. In this Standard, emissivity is reported as hemispherical emissivity (Eₕ) and normal emissivity (Eₙ).

The actual accumulation of data for measurement of such emissivity values is conventional and may be done by using, for example, a Beckman Model 4260 spectrophotometer with “VW” attachment (Beckman Scientific Inst. Corp.). This spectrophotometer measures reflectance versus wavelength, and from this, emissivity is calculated using the aforesaid ASTM Standard 1585-93.

Another term employed herein is “sheet resistance”. Sheet resistance (Rₛ) is a well known term in the art and is used herein in accordance with its well known meaning. It is here reported in ohms per square units. Generally speaking, this term refers to the resistance in ohms for any square of a layer system on a glass substrate to an electric current passed through the layer system. Sheet resistance is an indication of how well the layer or layer system is reflecting infrared energy, and is thus often used along with emissivity as a measure of this characteristic. “Sheet resistance” may for example be conveniently measured by using a 4-point probe ohmmeter, such as a dispensable 4-point resistivity probe with a Magnetron Instruments Corp. head, Model M-800 produced by Signatone Corp. of Santa Clara, Calif.

“Chemical durability” or “chemically durable” is used herein synonymously with the term of art “chemically resistant” or “chemical stability”. Chemical durability is determined by an immersion test wherein a 2″×5″ or 2″×2″ sample of a coated glass substrate is immersed in about 500 ml of a solution containing 4.05% NaCl and 1.5% H₂O₂ for 20 minutes at about 36° C.

“Mechanical durabilility” as used herein is defined by the following test. The test uses a Erichsen Model 494 brush tester and Scotch Brite 7448 abrasive (made from SiC grit adhered to fibers of a rectangular pad) wherein a standard weight brush or a modified brush holder is used to hold the abrasive against the sample. 100-500 dry or wet strokes are made using the brush or brush holder. Damage caused by scratching can be measured in three ways: variation of emissivity, Δhaze and ΔE for film side reflectance. This test can be combined with the immersion test or heat treatment to make the scratches more visible. Good results can be produced using 200 dry strokes with a 135 g load on the sample. The number of strokes could be decreased or a less aggressive abrasive could be used if necessary. This is one of the advantages of this test, depending on the level of discrimination needed between the samples, the load and/or the number of strokes can be adjusted. A more aggressive test could be run for better ranking. The repeatability of the test can be checked by running multiple samples of the same film over a specified period.

The terms “heat treatment”, “heat treated” and “heat treating” as used herein mean heating the article to a temperature sufficient to enabling thermal tempering, bending, or heat strengthening of the glass inclusive article. This definition includes, for example, heating a coated article to a temperature of at least about 1100 degrees F. (e.g., to a temperature of from about 550 degrees C. to 700 degrees C.) for a sufficient period to enable tempering, heat strengthening, or bending.

Glossary

Unless otherwise indicated the terms listed below are intended to have the following meanings in this specification.
Ag silver
TiO₂ titanium dioxide
NiCrOₓ an alloy or mixture containing nickel oxide and chromium oxide. Oxidation states may vary from stoichiometric to substoichiometric.
NiCr an alloy or mixture containing nickel and chromium
SiAINₓ reactively sputtered silicon aluminum nitride which may include silicon oxy-nitride. Sputtering target is typically 10 weight % Al balance Si although the ratio may vary.
SiAlOₓNₓ reactively sputtered silicon aluminum oxy-nitride
Zr zirconium
deposited on applied directly or indirectly on top of a previously applied layer, if applied indirectly, one or more layers may intervene
optical coating one or more coatings applied to a substrate which together affect the optical properties of the substrate
low e-stack transparent substrate with a low heat emissivity optical coating consisting of one or more layers
barrier layer deposited to protect another layer during processing, may provide better adhesion of upper layers, may or may not be present after processing
layer a thickness of material having a function and chemical composition bounded on each side by an interface with another thickness of material having a different function and/or chemical composition, deposited layers may or may not be present after processing due to reactions during processing
co-sputtering Simultaneous sputtering onto a substrate from two or more separate sputtering targets of two or more different materials. The resulting deposited coating may consist of a reaction product of the different materials, an un-reacted mixture of the two target materials or both.
Intermetallic compound A certain phase in an alloy system composed of specific stoichiometric proportions of two or more metallic elements. The metal elements are electron or interstitial bonded rather existing in a solid solution typical of standard alloys. Intermetallics often have distinctly different properties from the elemental constituents particularly increased hardness or brittleness. The increased hardness contributes to their superior scratch resistance over most standard metals or metal alloys.

### EXAMPLES

The following examples are intended to illustrate but not limit the present invention.

### Example 1

Various oxidizable barriers were deposited on an optical stack consisting of glass/TiO₂/NiCrOₓ/ TiO₂/Ag/NiCr/Ag/NiCrOₓ/SiAlNₓ. The oxidizable barriers included Zr metal, Zr doped with nitrogen but substantially metallic, Zr silicide, Zr silicide doped with nitrogen, and Ti₃Al.

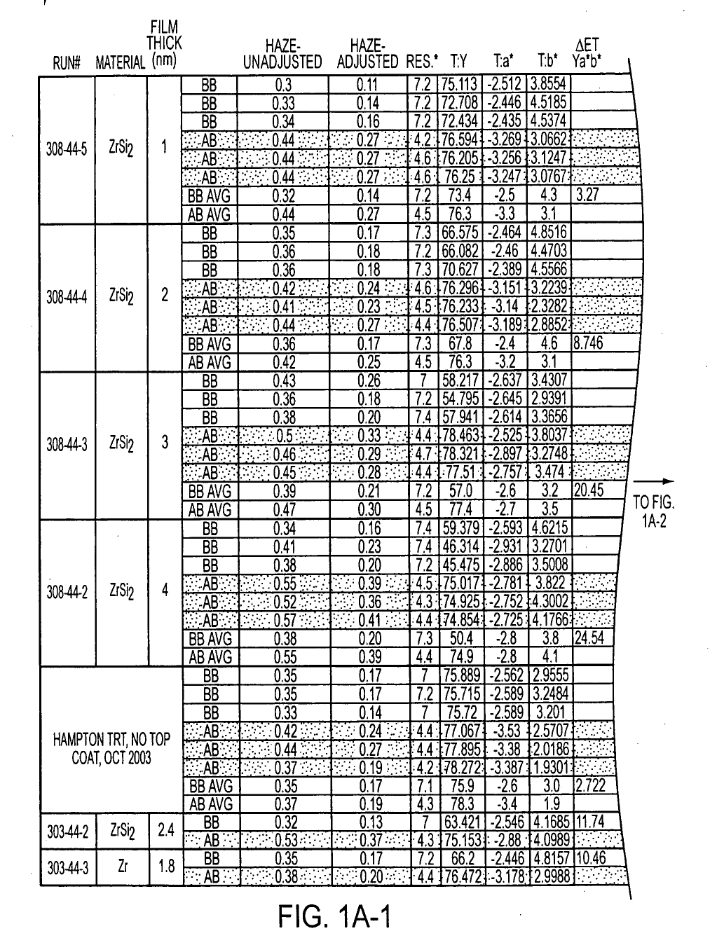

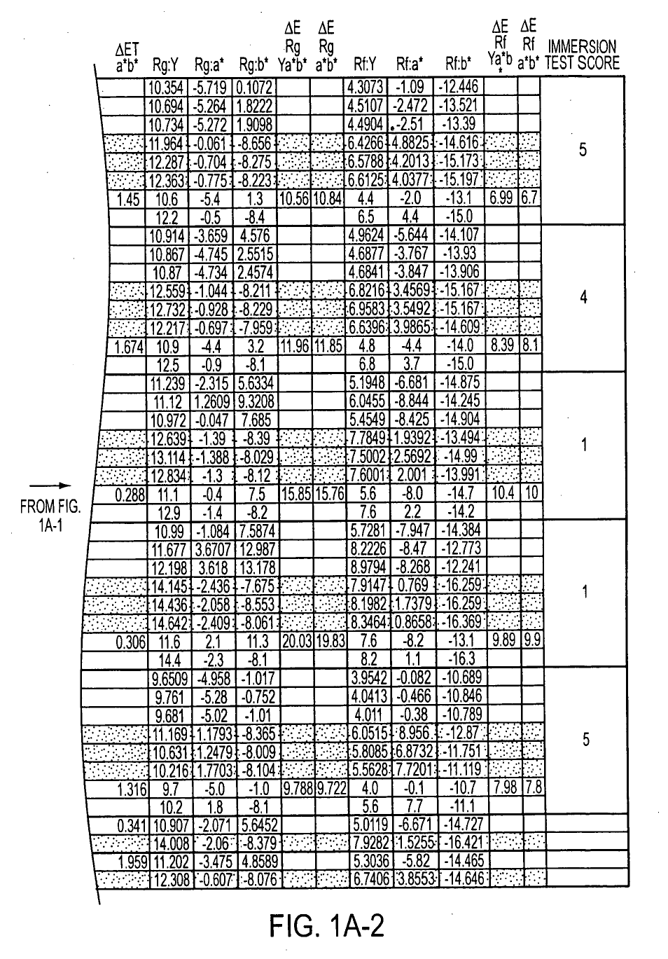

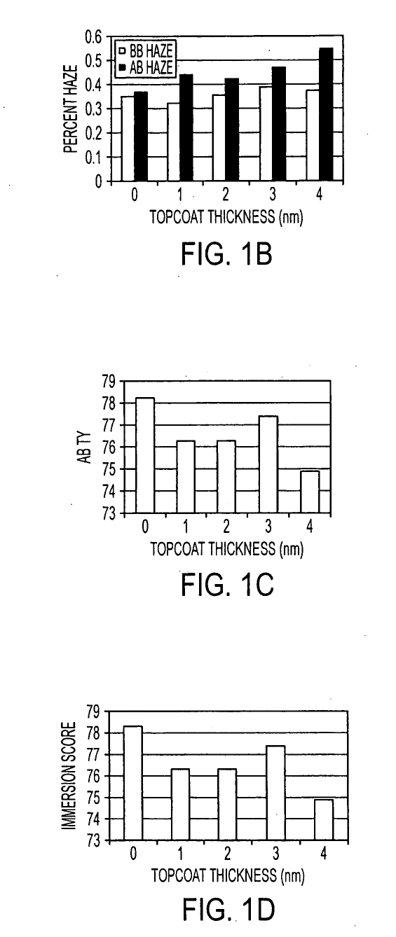

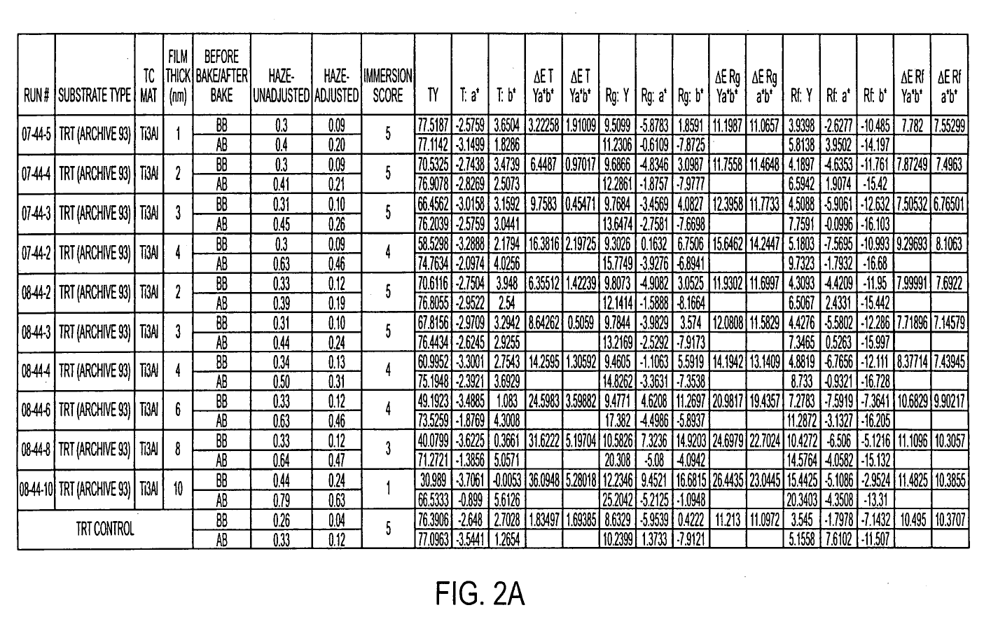

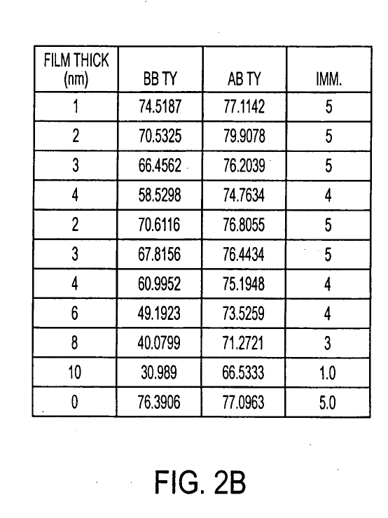

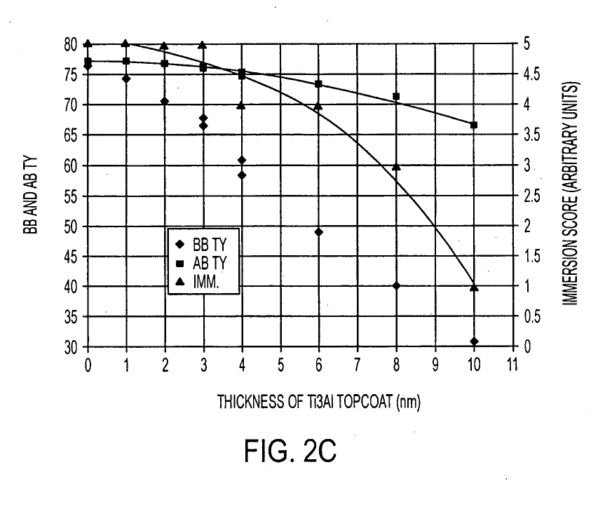

Corrosion protection for the silver containing stack was substantially improved with all of the oxidizable barriers tested, however, Zr silicide provided better corrosion protection than Zr metal. Nitrogen doping made no change in corrosion protection of the base metal as long as the doping levels were low. Increasing the amounts of nitrogen eventually decreased the metal corrosion protection. Zr silicide also provided better scratch protection than Zr metal. FIGS. 1 and 2 show the results for ZrSi₂ and Ti₃Al.

### Example 2

Immersion Test Procedure

Making the Stock Solution

320 grams of NaCl were weighed out into a beaker filled with hot reverse osmosis filtered water on a heated stir plate.

NaCl was added slowly so that it dissolved completely before adding more. Once the NaCl was completely dissolved the mixture was poured into a 1-gallon container. The beaker was rinsed out with RO water and poured into a jug to completely remove the NaCl from the beaker.

240 ml of 0.1 N KOH was measured into a 1 -gallon container.

Enough RO water was added to bring the final volume to 3.95 L.

Sample Preparation

Samples were cut to the desired size. 2″×2″ is the current typical size. If the samples are to be removed one at a time at different time intervals, a 5″×2″ size is easier to handle.

The samples must be kept free of fingerprints, cutting oil, or scratches. Contamination or scratches will bias results.

Preparing Solution for Use

250 ml of stock solution was added to a 1 L beaker then 250 ml 3.0% hydrogen peroxide was added. The stock solution is mixed 1:1 with the 3.0% hydrogen peroxide.

The final volume is 500 ml. The pH of this solution is 9.0. The final concentration of NaCl is 4.05% the final concentration of H₂O₂ is 1.5%.

The solution is warmed up to 36° C. on a hot plate and the pH of the solution is confirmed.

Running the Immersion Test

The samples are placed into a rack and placed into the heated solution.

The beaker(s) are put into a constant temperature water bath at 36° C. The water level is as high as the immersion fluid in the beakers.

The test is 20 minutes. At the end of the test, the samples are removed from the solution and placed into clean RO water to clean off any remaining immersion fluid.

The rack is taken out of the RO water and tapped on paper towels to remove water. The samples are placed film side up on low lint wipes to dry off the water. The film side of the samples are patted dry but not wiped off. If the film is severely damaged wiping the sample could remove the film. The glass side is also wiped dry. Make sure that water spots do not form. Water spots could affect damage calculations.

Analyzing the Samples

The samples can be analyzed by various methods including delta haze, delta E, and visual examination. To determine delta haze, the haze of the sample(s) is measured before immersion. To determine delta E, the film side reflection of the sample(s) is measured before immersion. These measurements are repeated after the immersion test is completed.

To calculate delta haze subtract the pre-test haze from the post-test haze. To calculate delta E: Delta E=(delta L*²+delta a*²+delta b*²)^{1/2}, where delta X is pre-test X is post-test X.

Table 1 shows the results of the corrosion test. The samples were visually examined and the results were recorded on a 1 to 5 scale. A score of 1 indicates that the sample surface was not visually corroded or damaged. A score of 2 through 5 corresponds to increasing damage in roughly 5% increments. A score of 5 indicates that about 20% or more of the thin film surface area was damaged.

TABLE 1
Corrosion Data for Standard Sputtered Zr and ZrSi₂
Corrosion Results for Topcoats on Single Silver Low-e Stack

| | Topcoat | | | | Total | | Immersion |
|---|---|---|---|---|---|---|---|
| | Thickness | Argon | | | Reactive | Power | Score (1 = no |
| Topcoat Material | (nm) | sccm | O2 sccm | N2 sccm | gas | (kW) | corrosion) |
| ZrSi2 (ZrSi2 target) | 5.0 | 80 | 0 | 0 | 0 | 2 | 1 |
| ZrSi2 (ZrSi2 target) | 5.0 | 80 | 0 | 0 | 0 | 2 | 1 |
| Zr | 4.5 | 100 | 0 | 0 | 0 | 10.3 | 1 |
| ZrOx | 5.0 | 100 | 20 | 0 | 20 | 10.3 | 1 |
| ZrOxNy | 4.2 | 100 | 0 | 20 | 20 | 10.3 | 1 |
| ZrOx | 4.9 | 100 | 30 | 0 | 30 | 10.2 | 1 |
| ZrOxNy | 5.7 | 100 | 10 | 20 | 30 | 10.2 | 1 |
| ZrOxNy | 5.1 | 100 | 20 | 20 | 40 | 10.1 | 1 |
| ZrNx | 4.3 | 100 | 0 | 45 | 45 | 11.1 | 1 |
| ZrNx | 5.9 | 100 | 0 | 70 | 70 | 11.4 | 2 |
| ZrNx | 4.8 | 100 | 0 | 60 | 60 | 11.2 | 3 |
| ZrNx | 5.3 | 100 | 0 | 80 | 80 | 11.4 | 3 |
| ZrNx | 6.0 | 100 | 0 | 90 | 90 | 11.5 | 3 |
| ZrOxNy | 4.0 | 100 | 10 | 45 | 55 | 11 | 4 |
| ZrNx | 4.3 | 100 | 0 | 55 | 55 | 11.3 | 4 |
| ZrOxNy | 4.2 | 100 | 20 | 45 | 65 | 10.5 | 4 |
| ZrOx | 3.8 | 100 | 78 | 0 | 78 | 9.7 | 4 |
| ZrNx | 4.4 | 100 | 0 | 100 | 100 | 11.06 | 4 |
| ZrOxNy | 6.7 | 100 | 56 | 45 | 101 | 10.9 | 4 |
| none | 0.0 | | | | | | 5 |

### Example 3

Scratch test procedure—scratch resistance (mechanical durability) was determined using a Scotch Brite™ scratch test. The test uses an Erichsen model 494 brush tester and Scotch Brite 7448 abrasive. The amount of damage can be measured in three ways: change in emissivity, haze, and film side reflection.

Scotch Brite™ (made from SiC grit adhered to fibers) pads were cut down from 6″ by 9″ to 2″ by 4″. The Erichsen brush tester was used as the mechanism to move the abrasive over the sample. A standard weight brush or a modified brush holder was used to hold the abrasive against the sample. New abrasive was used for each sample.

Damage caused from scratching was measured in three ways: variation of emissivity, delta haze, and delta E for film side reflectance. The variation of the emissivity is measured as the difference between the pre-scratched and scratched film. These measurements were then used in the following formula:
(E_{scratch}−E_{film})/(E_{glass}−E_{film}) Eqn. 1

Delta haze was measured by subtracting the haze of the scratched film from the haze of the prescratched film. For the heat treated samples, the haze of the pre-scratched film is subtracted from the haze of the scratched heat treated film.

Delta E measurements were made by measuring the film side reflection (Rf) of the undamaged and scratched films. For the heat treated samples, the Rf of the unscratched area is measured as well.

Delta L*, a*, and b* were put into this formula to calculate Delta E caused by the scratch:
Delta E=(delta L*²+delta a*²+delta b*²)^{1/2} Eqn. 2
The damage was evaluated in 3 different ways:
after the scratch test without any other post treatment
after scratch test followed by acidic immersion test
after scratch test and heat treating.
   Results

The immersion and the heat treating test reveal the damage generated by the Scotch Brite™. Since the immersion test is quick (20 minutes) and large or multiple samples can be treated at the same time, the immersion test is used after the scratch test since it makes small scratches more visible. The coating has been weakened from the scratch and once immersed or heat treated, more damage is revealed.

### Example 4

Co-Sputtering Process Setup

Co-sputtering was carried out in an in-line vacuum coater with downward sputtering stationary magnetron cathodes and included within the vacuum coater the means to move substrates under the cathodes at speeds of 0 to 15 meters per minute for coating. The co-sputtering cathode consisted of two one meter long sputtering cathodes about 40 mm apart. The sputtering setup was developed by Leybold Corporation and trade named “Twin-mag”. The two magnetron cathodes were powered by an AC bipolar power supply operating at a frequency of about 50 kilohertz. The power supply was a model BIG 100 made by Huttinger.

Sputtering targets used for the corrosion and scratch resisting layers were zirconium and silicon with 10 weight % aluminum (SISPA10 from Heraeus). Deposition ratios for the two materials were controlled by shield arrangements between the sputtering targets and substrates. The sputtering flux from the two targets deposited simultaneously in the same region of the substrate creating a reaction product of mixture of the two sputtering target materials.

Other equipment variations may be used to co-sputter such as use of two or more direct current cathodes. Separate power supplies allow varying power between the adjacent cathodes as an alternative method of controlling deposition ratios of materials. Side by side rotatable or tubular cathodes may also be used to co-sputter the corrosion and scratch resistant layers.

Other combinations of silicon and metal targets to deposit other suicides or combinations of metal and metal to create intermetallic layers may be used to deposit corrosion and scratch resistant layers.

Three chamber setups were performed to create three different ZrSi ratios for the co-sputtered corrosion and scratch resistant layer. The Zr target was placed on the load end side of the cathode and the SISPA10 SiAl target was on the unload side. The substrate moved from the load end towards the unload end during deposition. Atomic ratios in the deposited layers and sputtering conditions are shown in table 2 below. Atomic ratios were determined by XPS surface analysis techniques.

TABLE 2
Deposition parameters and atomic ratios.
Zr:SiAL Ratios from Three Co-sputtering Shield Setups

| Shield | Ar | Power | Pressure | Thickness | Line Speed | # of | | |
|---|---|---|---|---|---|---|---|---|
| Setup | (sccm) | (AC kW) | (mbar) | (nm) | (m/min) | passes | atomic % SiAl | |
| shield under | 100 | 8 | 4.90 | 4 | 4.13 | 1 | 21% | (Si only) |
| Si target | 100 | 8 | 4.90 | 3 | 5.5 | 1 | 21% | (Si only) |
| | 100 | 8 | 4.90 | 2 | 8.25 | 1 | 21% | (Si only) |
| no | 100 | 8 | 4.97 | 4 | 5.7 | 1 | 44% | |
| sputtering | 100 | 8 | 4.96 | 3 | 7.6 | 1 | 44% | |
| shields | 100 | 8 | 4.90 | 2 | 11.4 | 1 | 44% | |
| shield under | 100 | 8.2 | 5.49 | 4 | 4.10 | 1 | 58% | |
| Zr target | 100 | 8.2 | 5.47 | 3 | 5.46 | 1 | 58% | |
| | 100 | 8.2 | 5.49 | 2 | 8.19 | 1 | 58% | |

Note-Al was not included in the XPS measurement for the 21 at % sample. This at % is calculated from the Zr:Si ratio only.

Haze was found to be higher for the samples with corrosion and scratch resistant topcoat layers though the values were within the after temper specification of 0.6%. Table 3 shows haze and color trends for the low-e stacks with corrosion and scratch resistant topcoat layers. Haze was greater for topcoated samples in general, for increasing topcoat thickness, and decreasing Si content.

TABLE 3
Haze Levels Before and After Tempering for Single
Silver Low-e Samples with and without Topcoat

| | ZrSi2 | | |
|---|---|---|---|
| | Topcoat | Before | |
| | Thickness | Bake/After | Haze- |
| Run # | (nm) | Bake | Unadjusted |
| 26-44-1 | 4 | BB | 0.37 |
| | | AB | 0.64 |
| 26-44-2 | 3 | BB | 0.41 |
| | | AB | 0.59 |
| 26-44-3 | 2 | BB | 0.39 |
| | | AB | 0.47 |
| 33-44-3 | 4 | BB | 0.63 |
| | | AB | 0.58 |
| 33-44-4 | 3 | BB | 0.36 |
| | | AB | 0.47 |
| 33-44-5 | 2 | BB | 0.3 |
| | | AB | 0.41 |
| 49-44-3 | 4 | BB | 0.36 |
| | | AB | 0.56 |
| 49-44-4 | 3 | BB | 0.42 |
| | | AB | 0.45 |
| 49-44-5 | 2 | BB | 0.36 |
| | | AB | 0.42 |
| Control 1 | 0 | BB | 0.36 |
| | | AB | 0.44 |
| Control 2 | 0 | BB | 0.34 |
| | | AB | 0.39 |
| Control 3 | 0 | BB | 0.31 |
| | | AB | 0.39 |

The present invention should not be construed as limited to the particular embodiments described above. These embodiments should be regarded as illustrative and not restrictive. Variations may be made by one skilled in the art without departing from the scope of the present invention.

1. A method for making an article with improved corrosion and scratch protection, comprising
depositing an optical coating comprising one or more layers on a substrate,
depositing a layer comprising an unoxidized or partially oxidized or nitrided metal compound or intermetallic on said optical coating to provide a corrosion and scratch protection layer, wherein said metal compound or intermetallic is selected from the group consisting of metal silicide and metal aluminide, and
oxidizing or partially oxidizing said metal compound or intermetallic layer.

2. The method according to claim 1,further comprising heating said substrate in an atmosphere containing oxygen after depositing said metal compound or intermetallic layer on said optical coating.

3. The method according to claim 1, wherein said metal compound layer is deposited to a thickness of between 3 to 10 nm.

4. The method according to claim 3, wherein said metal compound layer is deposited to a thickness of between 4 to 6 nm.

5. The method according to claim 1, wherein the metal portion of said metal compound is selected from the group consisting of chromium, iron, titanium, zirconium, hafnium, niobium, tantalum, molybdenum, tungsten, iron, nickel, aluminum and silicon.

6. The method according to claim 6, wherein said metal portion is zirconium.

7. The method according to claim 1, wherein the metal compound is zirconium silicide.

8. The method according to claim 1 wherein said substrate is a transparent article.

9. The method according to claim 1, wherein said substrate is glass.

10. The method according to claim 9, wherein said optical coating includes one or more layers of TiO₂, NiCrOₓ, Ag, NiCr, and SiAlNₓ.

11. The method according to claim 10, wherein the metal compound is zirconium silicide.

12. The method according to claim 1, wherein said metal compound is deposited on said substrate by co-sputtering from at least two sources comprising metal and silicon.

13. The method according to claim 1, wherein said intermetallic is deposited by co-sputtering from at least two sources comprising a first metal and second metal which are capable of forming an intermetallic layer.

14. The method according to claim 13, wherein said intermetallic is an intermetallic compound.

15. An article with improved corrosion and scratch protection, comprising
a substrate,
an optical coating comprising one or more layers on the substrate, and
an outermost layer comprising a protective metal compound or intermetallic coating, wherein said metal compound or intermetallic is selected from the group consisting of metal silicide and metal aluminide.

16. The article according to claim 15, wherein said metal compound is at least partially oxidized.

17. The article according to claim 11, wherein said metal compound layer is between 3 to 10 nm thick.

18. The article according to claim 15, wherein said metal compound layer is between 3 to 6 nm thick.

19. The article according to claim 11, wherein the metal portion of said metal compound is selected from the group consisting of chromium, iron, titanium, zirconium, hafnium, niobium, tantalum, molybdenum, tungsten, iron, nickel, aluminum and silicon.

20. The article according to claim 18, wherein said metal portion is zirconium.

21. The article according to claim 15, wherein the metal compound is zirconium silicide.

22. The article according to claim 15, wherein said substrate is a transparent substrate.

23. The article according to claim 22, wherein said transparent substrate is glass with optical coatings deposited on it.

24. The article according to claim 23, wherein said optical coatings comprise one or more layers of TiO₂, NiCrOₓ, Ag, NiCr, and SiAlNₓ.

25. The article according to claim 24, wherein the metal compound is zirconium silicide.
